(19) United States
(12) Patent Application Publication
(10) Pub. No.: US 2012/0110000 A1
(43) Pub. Date: May 3, 2012

(54) METHOD AND APPARATUS FOR PERSONALIZED SEARCH

(75) Inventor: Pavel KRAVETS, Ashdod (IL)

(73) Assignee: SAP Portals Israel Ltd, Ra'anana (IL)

(21) Appl. No.: 12/916,543

(22) Filed: Oct. 31, 2010

(51) Int. Cl. G06F 17/30

(52) U.S. Cl. 707/769; 707/E17.014

(57) ABSTRACT

A method and apparatus for searching data by a processor at a computer, comprising: retrieving user context of a user using the computer, the user context comprising at least one data item, retrieval performed by a first computational entity executed by the computer; receiving a query issued by the user; attaching a data item of the at least one data item in the query; sending the query to a second computational entity for searching; and receiving results from the second computational entity.

### TECHNICAL FIELD

The present disclosure relates to computerized searches in general, and to a method and apparatus for providing personalized search results, in particular.

### BACKGROUND

Computer users nowadays search and consume information from various sources on a daily basis, and sometime as often as multiple times a day.

Some of the sources are on-demand sources, which are generally available to the public, for example over the internet. Generally, on-demand sources are not under the user's control but a user can generally access them whenever he or she desires to. A popular type of on-demand sources relates to social networks. A social network comprises structured data that relates to individuals or organizations, referred to as nodes, which are interconnected by one or more types of interdependency, such as friendship, kinship, common interest, financial exchange, likes, dislikes, beliefs, knowledge, prestige, or any other. A social network enables a user to explore a part of a network for which he or she has access according to the network policy. For example a person that participates in such network can view data related to another participant, wherein the data may depend on the relationships between the person and the other participant. Thus, a person may be able to access some or all of the available data related to other participant which indicated the person as an associate of some level, and only basic information such as name, related to other participants. Some social networks apply persistency rules, for example by forbidding a user to store on a persistent storage device information related to other users.

Other data sources, common especially in organizational environments, comprise on-premise sources, such as organizational databases, organizational charts, or the like which are owned, managed and optionally stored by the organization or by an entity in the organization's behalf. Such sources and their structure and contents are under the control of the organization, and may be of proprietary format.

Current search tools, such as search engines provide search results based on one or more queries issued by the user. A query may be introduced by typing texts, or by using a dedicated user interface, for example by navigating through menu options.

The used search engine retrieves results which match or otherwise provide information relevant to the query.

There is however a need in the art for a method and apparatus that will provide expanded search results, without further effort on the user's side.

### SUMMARY

A method and apparatus for method for searching data.

One aspect of the disclosure relates to a method for searching data by a processor at a computer, comprising: retrieving a user context of a user using the computer, the user context comprising one or more data items, retrieving performed by a first computational entity executed by the computer; receiving a query issued by the user; attaching one of the data items retrieved by the first computational entity to the query; sending the query to a second computational entity for searching; and receiving results from the second computational entity. Within the method, the first computational entity is optionally an application, a portal, or a demon. Within the method, the second computational entity is optionally a search engine, an application, or a web service. The method can further comprise selecting one or more data items from the user context to be attached to the query. The method can further comprise prioritizing or ordering the results in accordance with a level of matching the data item or the user context. Within the method, prioritizing or ordering is optionally performed by the first computational entity or the second computational entity. Within the method, the data item is optionally a personal detail or a professional detail of the user. The method can further comprise storing the user context on a persistent storage device.

Another aspect of the disclosure relates to an apparatus for data by a computer, comprising: a user context retrieval component for retrieving user context of a user using the computer, the user context comprising one or more data items, retrieving performed by a first computational entity executed by the computer; a query receiving component for receiving a query issued by the user; an information attachment component for attaching a data item of the data item retrieved by the first computational entity to the query; and a communication component for sending the query to a second computational entity for searching and receiving results, wherein at least one component is executed by a processor at a computer. Within the apparatus, the first computational entity is optionally an application, a portal, or a demon. Within the apparatus, the second computational entity is optionally a search engine, an application, or a web service. The apparatus can further comprise a selection component for selecting one or more data items from the user context to be attached to the query. The apparatus can further comprise a result processing component for prioritizing or ordering the results in accordance with a level of matching the data item or the user context. Within the apparatus, the result processing component is optionally executed by the first computational entity or the second computational entity. Within the apparatus, the data item is optionally a personal detail or a professional detail of the user. The apparatus can further comprise a storage device for storing the user context on a persistent storage device.

Yet another aspect of the disclosure relates to a computer readable storage medium containing a set of instructions for a general purpose computer, the set of instructions comprising: retrieving a user context of a user using a computer, the is user context comprising one or more data items, retrieving performed by a first computational entity executed by the computer; receiving a query issued by the user; attaching one of the data items retrieved by the first computational entity to the query; sending the query to a second computational entity for searching; and receiving results from the second computational entity. Within the computer readable storage medium the set of instructions can further comprise selecting one or more data items from the user context to be attached to the query. Within the computer readable storage medium, the set of instructions can further comprise prioritizing or ordering the results in accordance with a level of matching the data item or the user context. Within the computer readable storage medium, the first computational entity is optionally an application, a portal, or a demon, and the second computational entity is optionally a search engine, an application, or a web service.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic block diagram of an environment in which the disclosed method and apparatus is used;

FIG. 2 is a schematic illustration of an apparatus for providing personalized search results, in accordance with the disclosed subject matter;

FIG. 3 is a flowchart of the main steps in an exemplary embodiment of a personalized search method, in accordance with the disclosed subject matter; and

FIG. 4 is an exemplary embodiment of an apparatus for providing personalized search, in accordance with the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks,

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is that in currently available solutions, the input to the search engine is the query as entered by the user. The identity of the user, or other details are generally not available to the search engine and therefore not used, Thus, the retrieved results are general, and would typically not differ for different users issuing the same query at the same time. However, the user's details may be an important information source which can be put to use in personalizing the search results.

Technical aspects of the solution can relate to an apparatus and method which retrieve data in response to a query. The query is automatically issued together with user context, which comprises additional data items related to the user, so that such details can be put to use by the search engine. The context can include personal data such as address, marital status, hobbies, or the like, or professional data such as education, skills, places he works or worked for, or the like. When searching for information to retrieve in response to the query, the user data is taken into account as well, in order to improve, narrow or prioritize the results, in a personalized manner.

The user context can be used not only by search engines, but also by is environments such as social networks. When a user logs in to a social network, the network can suggest he contacts other people based on mutual interests and skills, close-by addresses or the like.

The user context can also comprise or point at group context, which may comprise fields relevant to a group of users, such as a team, a hobby club or the like.

For example, if the user context includes the name of the city in which the user lives, the results returned by the search engine in response to a commercially-related query can be localized, if applicable. In another example, if the user is a programmer working with a particular programming language and this data is part of the user context, the search results for a programming-related query can be retrieved or prioritized so that results relating to the particular language are displayed before other results.

The disclosed subject matter thus relates to retrieving user context by a first computational entity such as an application, a web service, a portal, or the like, and enriching a query with one or more data items from the user context.

The enriched query, with the additional data as extracted by or from the first computational entity, is then passed to a second computational entity such as a search engine, an application, a web service, a portal, for searching. The results returned by the second computational entity are optionally prioritized or ordered either by the second computational entity, or by the first computational entity upon receiving the results.

The user context may be represented in XML format, which may describe, for example a mini network in the case of searching in a social network. Thus, a user context may comprise the user, his connections in one or more social le networks, posts he posted in one or more blogs, people that work with him on the same project, people with shared expertise, or the like. This context is calculated ad-hoc by the first computational entity), after which it is passed to the second computational entity. It may be the responsibility of the first computational entity to create, update and keep the persistency rules. It will be appreciated that the context may be passed between the computational entities which reside on different domains, and that the context may be passed as service consumption during server to server communication.

In some embodiments, such as a user working in an organization having a portal, the user context can be constructed, maintained and provided to a search engine by the portal, which has access to multiple user data items. In other environments, the user context can be constructed, maintained and provided to search engines by a dedicated application which can be constantly resident in the memory, such as a demon.

In some embodiments of the disclosed subject matter, the data collection and transfer to search engines may have to be approved by the user so as not to damage the user's privacy.

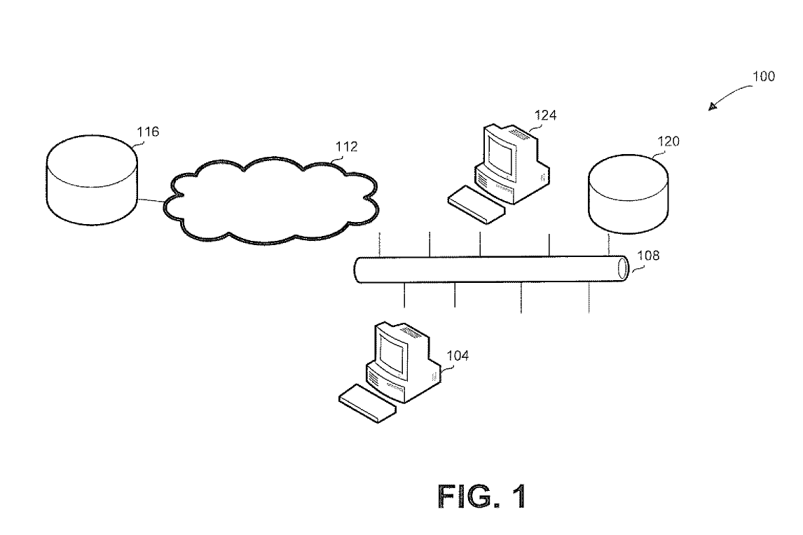

Referring now to FIG. 1, showing a schematic illustration of a typical environment in which the disclosed subject matter can be used.

The environment, referenced 100, provides search results for a user (not shown) using a computing platform 104, comprising a CPU and a memory device. Computing platform 104 can communicate with other entities that may provide data in response to queries, via a channel 108 such as a local area network (LAN), wide area network (WAN), intranet, Internet, or others.

The entities with which computing platform 104 can communicate to receive responses such as search results may include any further communication channel 112 such as the Internet, which enables communication with storage 116, optionally via additional computing platforms such as computing platform 124. Storage 116 can comprise a data source from which the user wishes to retrieve information, such as an on-demand system for example a social network. It will be appreciated by a person skilled in the art that storage 116 can be comprised of multiple storage devices and/or one or more servers for managing the storage.

The entities accessible to the user may also include entities on the same network, for example behind the same firewall. The entities may include storage device 120, optionally accessible through computing platform 124. Storage device 120 optionally stores an on-premise data source such as an HR database, an organizational chart, or the like, which contains information relevant for a group the user belongs to, such as an organization.

Some embodiments of the disclosed subject matter enable a user to issue a search request which includes a user context, and receive information that takes into account data from the user context. The data may be used for filtering the search result and returning fewer results than the results that would have been retrieved without a user context. Alternatively, the user context may be used for prioritizing the returned results, so that results that have higher matches with the user context, are displayed before results having lower matches.

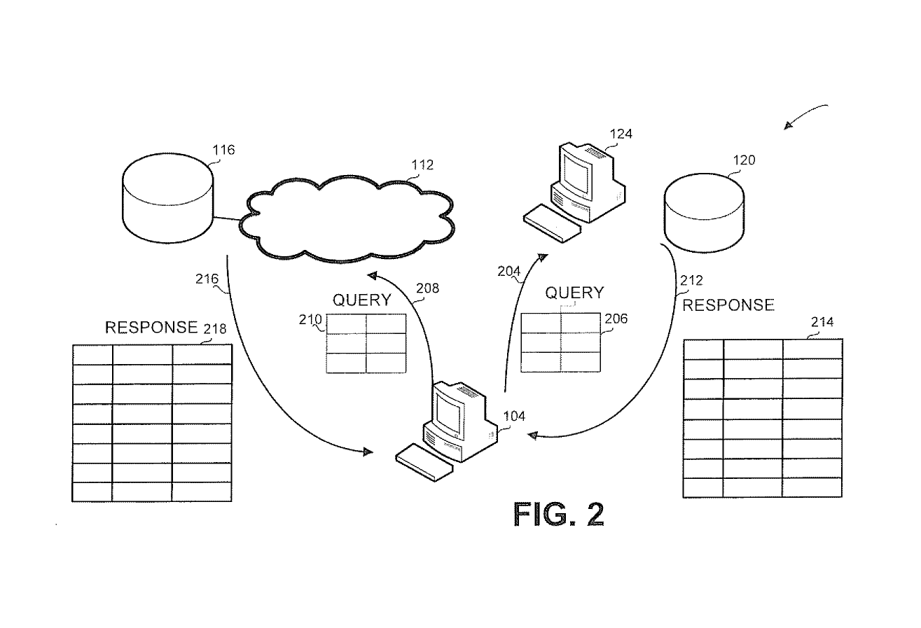

Referring now to FIG. 2, showing a schematic illustration of an exemplary apparatus for providing expanded search result.

The apparatus comprises computing platform 104 used by a user, as detailed in association with FIG. 1 above. When issuing a request, such as internal query 204, wherein internal relates to being processed within by an entity within the organization, or external query 208, which is to be processed by an external entity, such as a search engine, additional information comprising details relevant to the users is thatched to the request, Thus, data 206 is attached to query 204, and data 210 is attached to external query 208. It will be appreciated that data 206 can differ from data 210. A user may be willing to expose more details to a search engine or another entity within an organization, than to external publicly accessible search engines.

The search engine or another entity analyzes the request together with the user data, and retrieves relevant information. The level to which the user information is considered can depend on the particular search engine. Thus, the search results can consider the user context fields similarly to the original query, i.e., as adding additional query fields. The additional query fields can be used to limit the search results, i.e., impose additional limitations (AND operation). Alternatively, the user context can be used for expanding the search results and providing results that would not have been retrieved otherwise (OR operation).

In some embodiments of the disclosure, only some of the fields of the user context are attached to the query and referred to by the search engine. For example, if the query comprises professional terms, fields related to the professional sides of the context are attached to the query, and vice versa for personal queries.

In some embodiments, the original query can be executed as usual, and then the results may be filtered such that those results which do not match the user context are not returned to the user at all. Alternatively, the query can be performed as usual, followed by ordering or prioritizing the results in accordance with the user context, such that results that have higher match with the user context are presented before results having lower match.

Results 212 returned for internal query 204, or results 218 returned for external query 216 are thus personalized and take into account the user context.

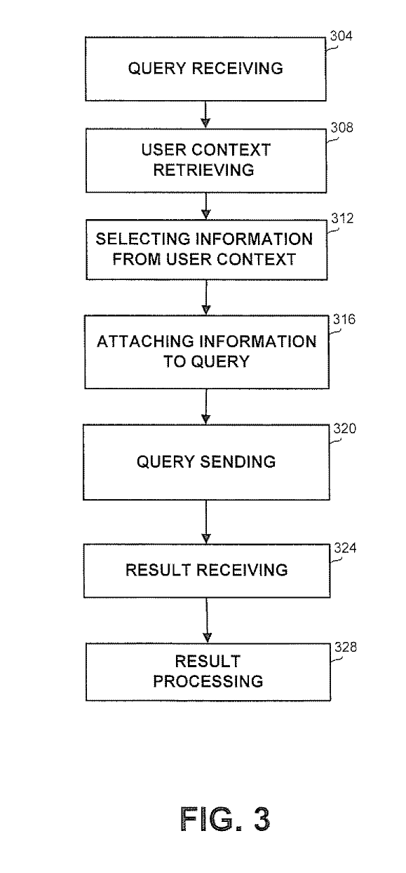

Referring now to FIG. 3, showing a flowchart of the main steps in a method for personalized search.

At query receiving 304, a query is received from the user. The query may be intended to be responded by an internal data source, i.e. data source maintained by the organization the user is associated with, or by an external data source such as a publicly available search engine.

At user context retrieving 308, user context is retrieved, which comprises one or more data items related to the user. The details may include personal details, professional details or both, or nay other detail. The context may be retrieved by an application, a demon, a portal or any other computational entity which has access to the user context or to any user details. It will be appreciated that query receiving 304 and user context retrieving 308 can be performed at any required order, or simultaneously.

At optional information selection 312, some or all the user context as retrieved at user context retrieving 308 is may be selected, for example in accordance with the query. For example, professional-related fields may be selected for a professional-related query, geographic locations such as private or business address can be attached to a location-related query, or the like.

At information attaching 316, the information may be attached to the query. The attachment manner may depend on the query format used, and on the protocol in which the user's computing platform, browser or another component communicates with the search engine.

At query sending 320 the query with the attached information as retrieved from the user context is sent for searching, either at an internal search engine or an external one. The search engine can be a commercial search engine, an application, a web service, a portal or any other computational entity.

At result receiving 324 results are received from the search engine by the browser or another program presenting information to the user.

At optional result processing 328, the results as retrieved by the search engine are processed in accordance with the user context. Processing may include filtering results which are not in accordance with the user context, prioritizing the results according to a matching degree between each result and the user context, or the like. Filtering or prioritizing may also take into account fields or data items of the user context which were not attached to the query.

It will be appreciated that result processing 328 can alternatively be performed by the search engine, prior to sending the results. The search engine can thus filter or prioritize the results so that they are received and can be displayed without further processing.

Optionally, the results, or user's selections are stored on a persistent storage device and may be used in further searches as part of or in addition to the user context.

Also, a common database or another storage may be maintained which stores the user context and retrieved information which is relevant to one or more users. Thus, a team context may be maintained which comprises terms and fields of interest relevant to a team or another group, and search results which are highly correlated with such terms.

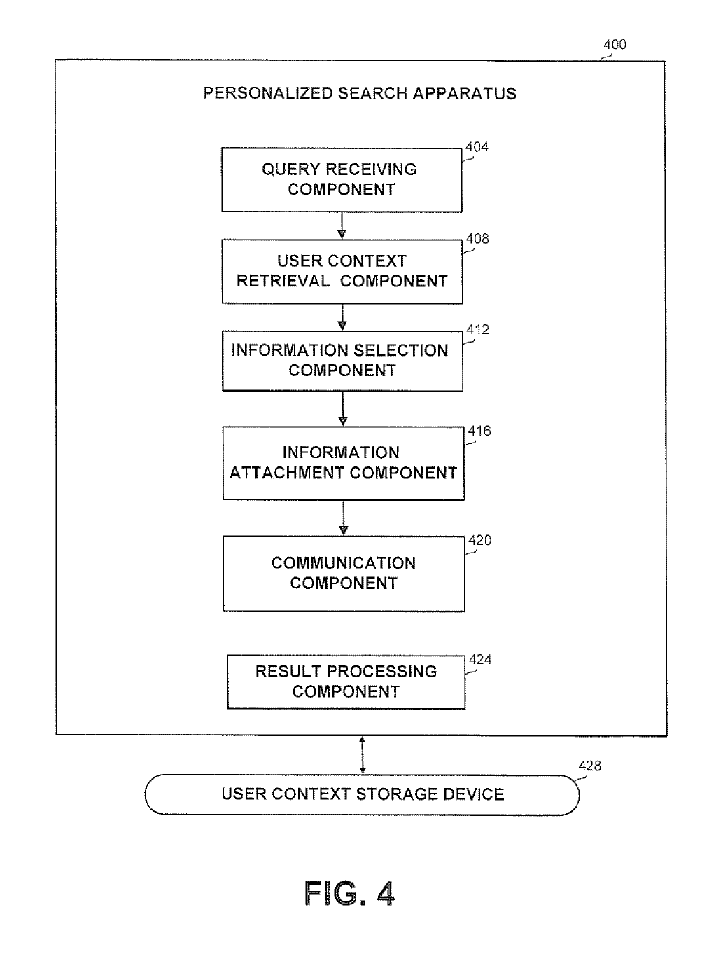

Referring now to FIG. 4, showing an exemplary embodiment of an apparatus for providing personalized search, in accordance with the disclosed subject matter.

The apparatus, referred 400 comprises one or more components, which may be implemented as inter-related sets of computer instructions. It will be appreciated that the division into components is conceptual and exemplary, and may depend in design choices.

Personalized search apparatus 400 comprises query receiving component 404 for receiving a query as introduced by a user. The query may be intended to be responded by an internal data source or an external data source.

User context retrieval component 408 is responsible for retrieving user context, which comprises one or more details related to the user. The details may include personal details, professional details or both.

The user context may be retrieved from a portal the user is viewing or logged into, by a registration to a context maintenance service, or the like. The user context may also comprise or point at group context fields.

Information selection component 412 selects some or all the user context as retrieved by user context retrieval component 408 to be attached to the query received by query receiving component 404. The information may be selected in accordance with the query. For example, professional-related fields may be attached a professional-related query, geographic locations such as private or business address can be attached to a location-related query, or the like. Alternatively, the information may be selected in accordance with the query destination, i.e., which search engine or application the query is sent to.

Information attachment component 416 is responsible for attaching the information to the query. The attachment manner may depend on the query format used, and on the protocol in which the user's computing platform, browser or another component communicates with the search engine.

Communication component 420 is responsible for communicating with a search engine, another program, environment, or computing platform. Communication includes at least sending the query with the additional data as retrieved from the user context, and receiving back results.

Result processing component 424 is responsible for processing the results received from the search engine. Processing may include filtering results which are not in accordance with the user context, prioritizing the results according to a matching degree between each result and the user context, or the like.

It will be appreciated that the results can alternatively be processed by the search engine, prior to sending back the results. The search engine can thus filter or prioritize the results so that they are received and can be displayed without further processing.

Personalized search apparatus 400 may further be on communication with user context storage device 428 which may store user context, processing results in accordance with user context, group context, or the like.

The disclosed method and apparatus provide for personalized search, in which user context is retrieved by one program or entity, and parts thereof are sent together with a user query to another entity, which performs the search. The search results thus relate to the user context and are personalized rather than uniform for all users issuing the same query.

It will be appreciated by a person skilled in the art that the disclosed method and apparatus are exemplary only and that multiple other implementations and variations of the method and apparatus can be designed without deviating from the disclosure. In particular, different division of functionality into components, and different order of steps may be exercised. It will be further appreciated that components of the apparatus or steps of the method can be implemented using proprietary or commercial products.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for searching data by a processor at a computer, comprising:
retrieving a user context of a user using the computer, the user context comprising at least one data item, retrieving performed by a first computational entity executed by the computer;
receiving a query issued by the user;
attaching a data item of the at least one data item retrieved by the first computational entity to the query;
sending the query to a second computational entity for searching; and
receiving results from the second computational entity.

2. The method of claim 1 wherein the first computational entity is an application, a portal, or a demon.

3. The method of claim 1 wherein the second computational entity is a search engine, an application, or a web service.

4. The method of claim 1 further comprising selecting one or more data items from the user context to be attached to the query.

5. The method of claim 1 further comprising prioritizing or ordering the results in accordance with a level of matching the data item or the user context.

6. The method of claim 5 wherein prioritizing or ordering is performed by the first computational entity or the second computational entity.

7. The method of claim 1 wherein the at least one data item is a personal detail or a professional detail of the user.

8. The method of claim 1 further comprising storing the user context on a persistent storage device.

9. An apparatus for data by a computer, comprising:
a user context retrieval component for retrieving user context of a user using the computer, the user context comprising at least one data item, retrieving performed by a first computational entity executed by the computer;
a query receiving component for receiving a query issued by the user;
an information attachment component for attaching a data item of the at least one data item retrieved by the first computational entity to the query; and
a communication component for sending the query to a second computational entity for searching and receiving results,
wherein at least one component is executed by a processor at a computer.

10. The apparatus of claim 9 wherein the first computational entity is an application, a portal, or a demon.

11. The apparatus of claim 9 wherein the second computational entity is a search engine, an application, or a web service.

12. The apparatus of claim 9 further comprising a selection component for selecting one or more data items from the user context to be attached to the query.

13. The apparatus of claim 9 further comprising a result processing component for prioritizing or ordering the results in accordance with a level of matching the data item or the user context.

14. The apparatus of claim 13 wherein the result processing component is executed by the first computational entity or the second computational entity.

15. The apparatus of claim 9 wherein the at least one data item is a personal detail or a professional detail of the user.

16. The apparatus of claim 9 further comprising a storage device for storing the user context on a persistent storage device.

17. A computer readable storage medium containing a set of instructions for a general purpose computer, the set of instructions comprising:
retrieving a user context of a user using a computer, the user context comprising at least one data item, retrieving performed by a first computational entity executed by the computer;
receiving a query issued by the user;
attaching a data item of the at least one data item retrieved by the first computational entity to the query;
sending the query to a second computational entity for searching; and receiving results from the second computational entity.

18. The computer readable storage medium of claim 17 wherein the set of instructions further comprises selecting one or more data items from the user context to be attached to the query.

19. The computer readable storage medium of claim 17 wherein the set of instructions further comprises prioritizing or ordering the results in accordance with a level of matching the data item or the user context.

20. The computer readable storage medium of claim 17 wherein the first computational entity is an application, a portal, or a demon, and the second computational entity is a search engine, an application, or a web service.
